(19) United States
(12) Patent Application Publication
(10) Pub. No.: US 2016/0208693 A1
(43) Pub. Date: Jul. 21, 2016

(54) POWER PLANT HAVING A GAS TURBINE AND A HYDROGEN-COOLED GENERATOR

(71) Applicant: SIEMENS AKTIENGESELLSCHAFT, München (DE)

(72) Inventors: Esteban Grau Sorarrain, Dusseldorf (DE); Christian Jäkel, Duisburg (DE); Mario Koebe, Mulheim an der Ruhr (DE); Matthias Kowalski, Mulheim an der Ruhr (DE); Christoph Lehmann, Neukirchen-Vluyn (DE); Andrey Mashkin, Koln (DE); Olga Plotnikova, Wuppertal (DE); Carolin Schild, Mulheim an der Ruhr (DE)

(73) Assignee: Siemens Aktiengesellschaft, Munich (DE)

(21) Appl. No.: 15/023,393

(22) PCT Filed: Sep. 15, 2014
(86) PCT No.: PCT/EP2014/069583

§ 371 Date: Mar. 20, 2016

(30) Foreign Application Priority Data
Sep. 27, 2013 (DE) 10 2013 219 548.6

(51) Int. Cl. F02C 3/22; F01D 15/10; H02K 7/18; F02C 9/40

(52) U.S. Cl. CPC F02C 3/22; F02C 9/40; F01D 15/10; H02K 7/1823

(57) ABSTRACT

A power station having a gas turbine, a generator driven by the gas turbine for generation of electrical power, and a hydrogen cooling circuit for discharging lost heat from the generator, wherein the hydrogen cooling circuit has a feed line for feeding hydrogen from a hydrogen tank into the generator and a discharge line for discharging heated hydrogen from the generator, and wherein the discharge line is connected to a mixing device, such that the heated hydrogen from the discharge line can be mixed with a further fuel and is fed by means of a fuel feed line to the gas turbine.

### CROSS REFERENCE TO RELATED APPLICATIONS

This application is the US National Stage of International Application No. PCT/EP2014/069583 filed Sep. 15, 2014, and claims the benefit thereof. The International Application claims the benefit of German Application No. DE 102013219548.6 filed Sep. 27, 2013. All of the applications are incorporated by reference herein in their entirety.

### FIELD OF INVENTION

The invention relates to a power plant with a gas turbine and a hydrogen-cooled generator driven by the gas turbine for generating electrical energy.

### BACKGROUND OF INVENTION

It has long been generally known to discharge the lost heat in generators by means of a cooling gas. Air was originally provided here as the cooling gas. However, air-cooled generators are only intended for low power outputs, up to a maximum of 300 MVA, since the cooling effect that can be achieved with air is necessarily limited and therefore, at higher power outputs, the required cooling cannot be ensured with air.

Hydrogen gas, which allows a much greater cooling effect to be achieved in comparison with air, which moreover can be further increased by putting the hydrogen gas under pressure and carrying out the cooling under positive pressure, is used with preference as a coolant for generators of a higher power output. Since hydrogen has a greater thermal capacity and a greater thermal conductivity than air, by filling the generator casing with hydrogen the heat can be dissipated better from the generator than would be possible with air. However, cooling with hydrogen gas requires an additional, not inconsiderable effort, which is reflected in the cost, both in acquisition and also later in operation. EP 1 580 868 A1 discloses such a hydrogen-cooled generator, in which the hydrogen flows through the generator in a closed circuit.

Gas turbines can be operated with a wide variety of fuels or fuel mixtures. Current developments are heading in the direction that, because of the increasing oversupply of electrical energy, for example from renewable sources, this intermittent oversupply is increasingly being used for hydrogen generation, and this hydrogen, together with a further combustible gas, such as for example after mixing with natural gas, is converted back into electrical energy by combustion in gas turbines.

### SUMMARY OF INVENTION

The object of the invention is therefore to improve a power plant which comprises such a gas turbine and a hydrogen-cooled generator driven by the gas turbine for generating electrical energy to the extent that optimized operation of the power plant is possible.

This object is achieved by the power plant with the features of the claims.

The fact that the hydrogen used for cooling the generator is heated by absorbing the lost heat of the generator and is fed via a mixing station, in which it is mixed with a further fuel—in particular natural gas—, to a gas turbine for combustion means that the hydrogen can be used more efficiently. On the one hand, there is then no longer any need for the cooler that is otherwise necessary in the hydrogen cooling circuit for re-cooling the hydrogen, which leads to a cost saving. On the other hand, the overall efficiency of the power plant will improve, since the hydrogen from the hydrogen cooling circuit is already preheated when it is fed to the gas turbine, so that the fuel consumption in the power plant is also reduced. Altogether, the operation of the power plant can thus be optimized.

If a separating device is additionally arranged in the discharge line and is formed in such a way that only hydrogen passes through, a fuel with a very high degree of purity can be fed to the gas turbine.

### BRIEF DESCRIPTION OF THE DRAWINGS

The invention is now to be explained by way of example on the basis of the figures that follow, in which:

FIG. 1 schematically shows a closed hydrogen cooling circuit known from the prior art for cooling a generator,

FIG. 2 schematically shows an arrangement according to the invention of a generator and a gas turbine of the power plant.

### DETAILED DESCRIPTION OF INVENTION

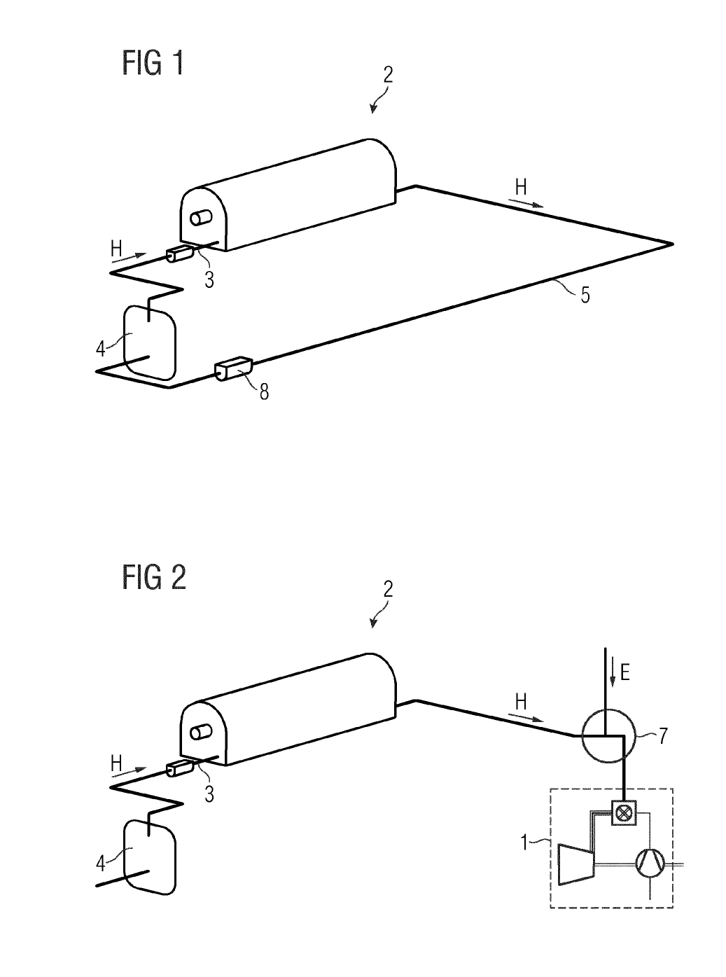

In FIG. 1, a hydrogen-cooled generator 2 is schematically represented. Arranged on one end face of the generator 2 is a feed line 3. Arranged on the other end face is a discharge line 5. The hydrogen-cooled generator 2 has a casing. Arranged in the casing are a stator and a rotor, which are not represented any more specifically. Hydrogen H is stored in a hydrogen tank. The hydrogen H is used as a coolant for the hydrogen-cooled generator 2, in that the hydrogen H flows from the hydrogen tank via the feed line 3 into the generator 2, where it absorbs the lost heat of the generator that is produced there. Subsequently, the heated-up hydrogen H flows back into the hydrogen tank via the discharge line 5 and via a cooler, which is not represented any more specifically, for cooling down the hydrogen H heated in the generator. Consequently—if the usual losses caused by leakage etc. are disregarded—the hydrogen H passes through a largely closed circuit.

In FIG. 2, the arrangement according to the invention comprising a gas turbine 1, the generator 2 driven by the gas turbine 1 for generating electrical energy and the hydrogen cooling circuit for discharging lost heat from the generator 2 is then schematically represented. The fact that the discharge line 5 is now connected to a mixing device 7, in which the heated hydrogen H from the discharge line 5 can be mixed with a further fuel E, and this mixture is fed via a fuel feed line 6 to the gas turbine 1, means that the heated hydrogen no longer has to be cooled down in a cooler, with the effort that involves. The resultant lost energy therefore no longer has to be discarded, but can even be fed to the gas turbine as a preheated combustion gas. Although this creates an open hydrogen cooling circuit, that is to say fresh hydrogen H has to be constantly fed to the generator 2, on the other hand less fuel has to be fed on the gas turbine side, so that the balance as such of amounts consumed should be virtually identical. Since, however, the hydrogen fed to the gas turbine 1 is preheated, a better efficiency can be achieved for the gas turbine 1 with the same amount of fuel, which consequently improves the overall efficiency of the power plant. This can be improved still further if a separating device 8 for cleaning the hydrogen heated in the generator 2 is provided in the discharge line 5. Additional control fittings arranged in the discharge line 5—but not represented in FIG. 2—for controlling the pressure and/or the flow rate set the mass flow of hydrogen that flows into the mixing device 7 and is heated in the generator, in order in this way to achieve a mixing ratio with the further fuel—such as for example natural gas—that is optimal for the combustion in the gas turbine. Altogether, with the present invention optimized operation of the power plant is possible, both from the point of view of the balance of consumable materials, that is to say the fuels and coolants required for the operation of the power plant, and from the point of view of the overall efficiency.

1.-4. (canceled)

5. A power plant comprising:
a gas turbine,
a generator driven by the gas turbine for generating electrical energy, and
a hydrogen cooling circuit for discharging lost heat from the generator, the hydrogen cooling circuit having a feed line for feeding hydrogen from a hydrogen tank into the generator and a discharge line for discharging heated hydrogen from the generator, and
a mixing device, wherein the discharge line is thus connected to the mixing device, so that the heated hydrogen from the discharge line is mixed with a further fuel and this mixture is fed via a fuel feed line to the gas turbine.

6. The power plant as claimed in claim 5,
wherein the further fuel is natural gas.

7. The power plant as claimed in claim 5, further comprising:
a separating device for cleaning the heated fuel in the discharge line.

8. The power plant as claimed in claim 5, further comprising:
control fittings arranged in the discharge line for controlling the pressure and/or the flow rate of the heated hydrogen flowing into the mixing device.
